(19) United States
(12) Patent Application Publication
(10) Pub. No.: US 2025/0088755 A1
(43) Pub. Date: Mar. 13, 2025

(54) Flicker Mitigation for Image Capture

(71) Applicant: Apple Inc., Cupertino, CA (US)

(72) Inventor: Francesco Cannillo, Munich (DE)

(21) Appl. No.: 18/464,683

(22) Filed: Sep. 11, 2023

(51) Int. Cl. H04N 23/745; G06T 7/00; H04N 23/71; H04N 25/531; H04N 25/532

(52) U.S. Cl. CPC H04N 23/745; G06T 7/0002; H04N 23/71; H04N 25/531; H04N 25/532; G06T 2207/30168

(57) ABSTRACT

This disclosure describes adaptive synchronization techniques for mitigating the impact of light flickering on images captured with active pixel sensor (APS) image sensors. In particular, these techniques apply to applications wherein the precise time at which an image is captured is not a critical parameter, such as machine vision (MV) applications. The techniques consist of repeating image captures until an image quality criterion is met, before transmitting the image to another system or processor for post-processing. The time between successive image captures may depend on the complexity of the on-sensor auto-exposure algorithm. The image quality criterion could change dynamically, e.g., based on parameters set by a host processing unit of the image capture system. One exemplary image quality criterion could be to determine that an average illuminance value for a region of interest (ROI) with a given image is within a threshold amount of a target average ROI illuminance value.

### TECHNICAL FIELD

This disclosure relates generally to the fields of digital image processing and light source flicker mitigation. More particularly, but not by way of limitation, it relates to techniques for mitigating the impact of light flickering on images captured with active pixel sensor (APS) image sensors.

### BACKGROUND

The advent of mobile, multi-function devices, such as smartphones and tablet devices, has resulted in a desire for small form factor cameras capable of generating high levels of image quality for integration into such mobile, multi-function devices. Increasingly, as users rely on these multi-function devices as their primary devices for day-to-day communications, the need for improved image quality levels in a wide variety of image capture environments—while maintaining performance levels that users have become accustomed to—has become an increasingly important challenge to solve.

Artificial light sources produce an illumination that varies periodically, e.g., with a frequency that spans from the rectified power grid frequency of 100/120 Hz (up to a few kHz, in the case of light-emitting diode (LED) lights). The variation in light intensity can impact the quality level of images captured, especially by rolling shutter image sensors. Many modern solid-state imagers integrate the photocurrent produced by the pixel photodiode onto a capacitance, thereby generating a voltage signal that can be easily read-out. In rolling shutter image sensors, the read-out circuitry is time-shared by reading out the pixel array on a row-by-row basis at a fixed time interval (i.e., the “line time”). As a consequence, different rows of pixels on the image sensor may capture different levels of light intensity, thereby causing shading or band artifacts in the captured image.

When the integration time of an image sensor is comparable to the flickering period of a light source that is lighting the image sensor's environment, both rolling shutter sensors and global shutter image sensors risk capturing completely dark images. Thus, it would be desirable to develop improved image capture techniques to mitigate the quality loss and/or artifacts created in such scenarios.

### SUMMARY

This disclosure describes adaptive synchronization techniques for mitigating the impact of light flickering on images captured with active pixel sensor (APS) image sensors. In particular, these techniques apply to applications wherein the precise time at which an image is captured is not a critical parameter, such as machine vision (MV) applications. The techniques consist of repeating image captures until an image quality criterion is met, before transmitting the image to another system or processor for post-processing. The time between successive image captures may depend on the complexity of the on-sensor auto-exposure algorithm. The image quality criterion could change dynamically, e.g., based on parameters set by a host processing unit of the image capture system. One exemplary image quality criterion could be to determine that an average illuminance value for a region of interest (ROI) with a given image is within a threshold amount of a target average ROI illuminance value.

As such, devices, methods, and non-transitory computer readable media are disclosed herein to perform flicker mitigation techniques for image capture. In one embodiment, a method of digital image capture is disclosed, the method comprising: obtaining a first image captured by a first image capture device (e.g., an APS image sensor), wherein the first image is captured at a first exposure level; determining that the first image does not meet a first image quality criterion; obtaining a number, n, of additional images captured by the first image capture device, wherein, for each of the n additional images captured, the method further comprises: determining whether the respective additional image meets the first image quality criterion, wherein the first image capture device is configured to continue capturing the n additional images until a respective additional image meets the first image quality criterion; and performing at least one post-processing operation on the additional image that was determined to meet the first image quality criterion.

For example, the post-processing operation may comprise: sending the image that meets the first image quality criterion to another device, to another processor(s) of the same device, to an image signal processor (ISP) unit on the same device, or to a system on a chip (SoC) within the same device or another device, etc. Additionally, or alternatively, the post-processing operation may comprise: performing an image processing operation on the image, re-formatting the image, storing the image in a memory, etc.

In some embodiments, the first image capture device comprises a rolling shutter image sensor, and the first exposure level comprises an integration time for a given row of pixels on the rolling shutter image sensor. In other embodiments, the first image capture device comprises a global capture image sensor, and the first exposure level comprises an integration time during which all rows of pixels on the global capture image sensor are exposed.

In some embodiments, the first image quality criterion comprises determining that an average illuminance value for a region of interest (ROI) with a given image is within a threshold amount of a target average ROI illuminance value. In other embodiments, the first image quality criterion comprises determining that an ambient illuminance value associated with the capture of a given image is within a threshold amount of a target ambient illuminance value. In still other embodiments, the first image quality criterion is a dynamic image quality criterion (i.e., a quality criterion that may change over time, e.g., between the capture of a first image and the capture of a subsequent image or images).

In some embodiments, determining that the first image does not meet a first image quality criterion comprises: determining a presence of light source flicker associated with the capture of the first image (e.g., using a flicker sensor, an ambient light sensor (ALS) configured to measure flicker, or some combination of sensors thereof). In some such embodiments, determining the presence of light source flicker further comprises determining at least one of: an ambient illuminance value associated with the capture of the first image; a flicker frequency of the light source; or a flicker percentage of the light source.

In some embodiments, the method further comprises: discarding the first image; and/or discarding each of the n additional images that were not determined to meet the first image quality criterion.

In some embodiments, the method further comprises: applying a first amount of programmable delay prior to capturing at least one of the n additional images.

Various non-transitory computer readable media embodiments are disclosed herein. Such computer readable media are readable by one or more processors. Instructions may be stored on the computer readable media for causing the one or more processors to perform any of the techniques disclosed herein.

Various programmable electronic devices are also disclosed herein, in accordance with the program storage device embodiments enumerated above. Such electronic devices may include one or more image capture devices, such as optical image sensors/camera units; a display; a user interface; one or more processors; one or more sensors (e.g., ambient light sensors, flicker sensors, inertial measurement units (IMUs), etc.); and a memory coupled to the one or more processors. Instructions may be stored in the memory, the instructions causing the one or more processors to execute instructions in accordance with the various techniques disclosed herein.

### BRIEF DESCRIPTION OF THE DRAWINGS

FIG. 1 illustrates the impact of flickering light on images captured by rolling shutter image sensors.

FIG. 2 illustrates an example of adaptive synchronization in the presence of a flickering light source, according to one or more embodiments.

FIG. 3 is a flow chart illustrating a method of performing flicker mitigation in the presence of a flickering light source, according to one or more embodiments.

FIG. 4 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

### Introduction and Problem Background

As introduced above, in rolling shutter sensors, the sensor's is read out on a row-by-row basis, which can cause the different rows of pixels to capture different levels of light intensity, resulting in undesirable shading or band artefacts in the captured image.

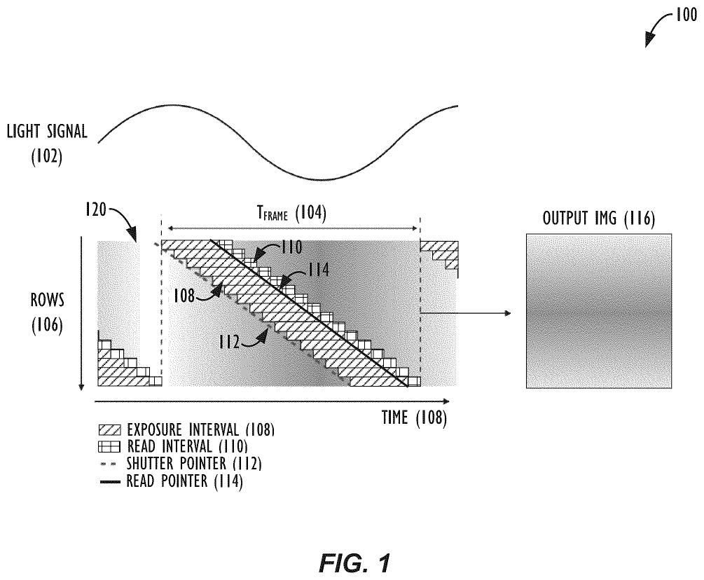

Turning now to FIG. 1, the impact of flickering light on images captured by rolling shutter image sensors is shown, e.g., in exemplary output image 116. Light signal 102 represents an intensity of a hypothetical light source over time (e.g., as shown by time axis 108 of graph 120). The vertical axis 106 of graph 120 represents the readout of rows of an exemplary rolling shutter image sensor from top to bottom.

The time it takes to read out one from in the exemplary graph 120 is represented by the interval, T_{FRAME} 104. The readout of the frame begins with the exposure interval for a given row(s), as shown by diagonal-shaded boxes 108. After the exposure of the given row(s), the pixel information is read out from the sensor, as shown by cross-hatched boxes 110. The dashed line 112, thus represents the position of the shutter pointer throughout the duration of the frame readout, while the solid line 114 represents the position of the read pointer throughout the duration of the frame readout.

Turning back now to exemplary output image 116, it may clearly be seen that the top and bottom rows 106 of the exemplary rolling shutter image sensor were exposed when the intensity of exemplary light signal 102 was at or near an intensity peak (resulting in brighter horizontal bands at the top and bottom of exemplary output image 116), while the rows 106 closer to the center of the exemplary rolling shutter image sensor were exposed when the intensity of exemplary light signal 102 was at or near an intensity “valley” or “trough” (resulting in darker horizontal bands at the center of exemplary output image 116). This unnatural light banding is a direct consequence of the sensor's rolling shutter operation and does not reflect the human perception of the real-world.

### Exemplary Flicker Mitigation Techniques

In some machine vision (MV) applications, the presence of shading or bands in captured images is of secondary importance, as the captured images are not typically used for photographic applications. Rather, specific information is often extracted from the captured images using dedicated algorithms for some other analysis or purpose. Nevertheless, light sources with 100% flicker percentage (FP) can cause the image sensor to not capture any image at all—as there may be images captured during time intervals in which no light is being emitted from the flickering light source. (Note: The term “flicker percentage” or “FP,” as used herein, refers to a metric used to describe the waveform shape in a period of the source luminance or of the illuminance on the image sensor. In particular, the FP of the illuminance on the sensor may be defined as: (Eₘₐₓ-Eₘᵢₙ)/(Eₘₐₓ+Eₘᵢₙ), where Eₘₐₓ and Eₘᵢₙ are the maximum and minimum illuminance on the image sensor, respectively.)

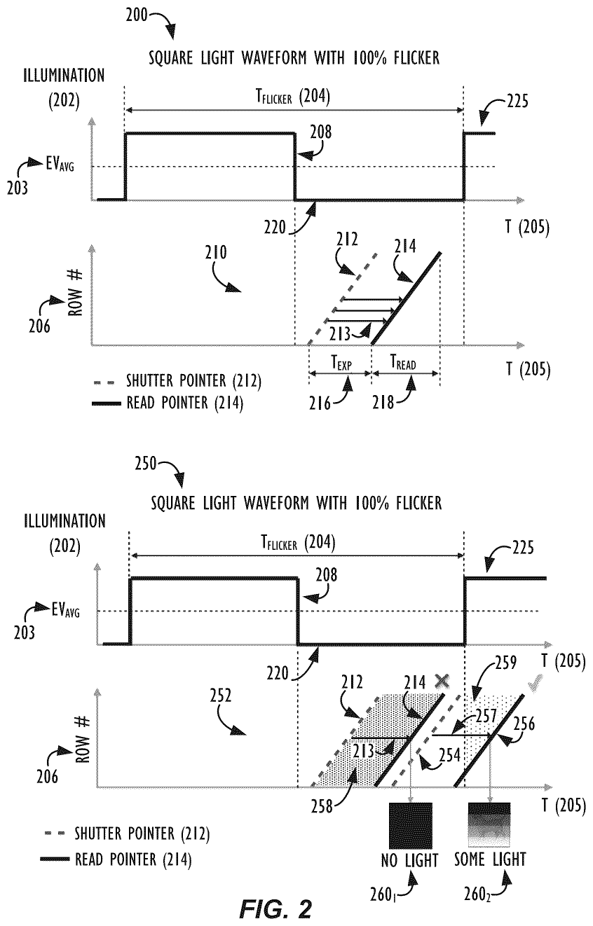

Turning now to FIG. 2, an example of adaptive synchronization in the presence of a flickering light source is illustrated, according to one or more embodiments. Although FIG. 2 illustrates the particular case of a rolling shutter image sensor, global shutter image sensors may also be affected by the same issues.

Turning first to graph 200, an example of a square light waveform with a 100% FP is shown. The horizontal axis 205 reflects time, and the vertical axis 202 reflects sensor illumination, with dashed line 203 reflecting the EV_{avg}, that is, the average amount of illuminance on the image sensor. The flicker period of the square waveform is represented by the interval, T_{FLICKER} 204. The amplitude of the square wave 208 represents the distance between the image sensor's Eₘₐₓ and Eₘᵢₙ values, as defined above. In this case, because FP is 100%, the intensity of the light waveform fluctuates all the way from the Eₘₐₓ value to the Eₘᵢₙ value during a single waveform period.

In some embodiments, a threshold determination of whether light source flicker is present may be made with the aid of one or more sensors embedded in a device, e.g., a flicker sensor, an ambient light sensor (ALS) configured to measure light source flicker, or some combination of sensors thereof. In such embodiments, determining the presence of light source flicker associated with the capture of a given image (e.g., light source flicker that is occurring in the scene prior to and/or contemporaneously with the capture of the given image) may involve performing signal processing to determine a flicker frequency associated with the light source and/or a light intensity sensor to attempt to estimate a flicker percentage of the light source.

As mentioned above, light sources with 100% FP can cause the image sensor to not capture any image at all, i.e., for images that are captured entirely during time intervals in which no light is being emitted from the flickering light source (see, e.g., interval 220). As illustrated in shutter readout graph 210 (wherein the horizontal axis 205 again reflects time, and the vertical axis 206 reflects the row from the sensor that is being read out), for an exemplary image whose readout is represented by shutter pointer dashed line 212 (wherein the pixels in each row are exposed during the intervals represented by arrows 213) and read pointer solid line 214, both the exposure time interval (T_{EXP} 216) and the readout time interval (T_{READ} 218) occur during the trough interval 220, during which no light is being emitted from the flickering light source. This lack of light may result in an exemplary image such as 260₁ (shown in graph 250) being read out from the image sensor, i.e., a completely black image. Thus, it would be desirable to employ an adaptive synchronization image capture technique, e.g., that could delay and/or re-capture the image at a different time, such that at least some amount of light from the flickering light source is present during the exposure time of the image sensor.

Turning now to graph 250, another example of a square light waveform with a 100% FP is shown, this time utilizing an adaptive synchronization technique to capture a version of the image with at least some amount of light from the flickering light source. As shown in graph 250, the shaded region 258 represents the timing of the exemplary image capture discussed above with reference to graphs 200 and 210. Region 258 is also marked with an “X” and displayed with completely black image 260₁ to indicate that a readout during this time interval would result in an exemplary image being captured with no lighting.

By contrast, as illustrated in shutter readout graph 252, for an exemplary image whose readout is represented by shutter pointer dashed line 254 and read pointer solid line 256, at least a portion of the exposure time interval (represented by exemplary row arrow 257) occurs during the light waveform's peak interval 225 (as represented by the lightly-shaded region 259), during which the full intensity of the flickering light source is being emitted. This partial presence of light during the exposure of the image may result in an exemplary image such as 260₂ being read out from the image sensor, i.e., a banded image, with dark bands that get lighter and lighter towards the image sensor row exposures that occurred (partially, and then fully) during the light waveform's peak interval 225.

As may now be appreciated, if both the exposure time T_{EXP} and read time T_{READ} of the image sensor occur during the interval in which no light is emitted, the captured image is completely dark-even in conditions in which the average illumination of the scene is not zero. In addition, in these conditions, the auto-exposure (AE) algorithm that determines T_{EXP} might not be able to converge to an exposure setting value that reflects the average scene illumination. For example, typically, an AE algorithm determines T_{EXP} based on the average brightness value of the image (or a region of interest (ROI) within the image), referred to herein as ROI_{AVE}.

Thus, in a first example, because ROI_{AVE} is proportional to T_{EXP}, the exposure time of image i+1 (i.e., T_{EXP} (i+1)) that is required to achieve a target ROI_{AVE_TARGET} can be calculated as:

$${T}_{EXP ( i + 1 )} = {T}_{EXP ( i )} * ( {ROI}_{AVE \_ TARGET} / {ROI}_{AVE \_ i} ) . \qquad ( Eqn . 1 )$$

Therefore, according to Eqn. 1, a dark image, e.g., caused by the condition of graph 210 may cause the exposure time of a next image, i.e., image i+1, to be overestimated with respect to the exposure time that would achieve ROI_{AVE_TARGET} with a constant illumination equal to the average value EV_{AVE}. In other words, a flickering light with 100% FP can cause an image sensor to cyclically oscillate between capturing under-exposed images and over-exposed images, in either of which important scene detail information might be lost.

In MV applications (or other applications in which the precise time at which the image is captured is not a critical parameter), however, it is possible to introduce the adaptive synchronization techniques of the present disclosure, as introduced above, with reference to graphs 250 and 252. One implementation of the adaptive synchronization techniques disclosed herein comprises repeating image captures with the same exposure setting (i.e., T_{EXP}) until a desired image quality criterion is met, i.e., before modifying T_{EXP} according to the AE algorithm (running on the image sensor itself) being used, and transmitting the image to the system host.

The time between the image captures may depend on the complexity of the on-sensor AE algorithm being used (e.g., if a detailed histogram analysis is being performed on the captured image data, etc.). The image quality criterion could also change dynamically from frame to frame, e.g., based on parameters set by the host processing unit of a system. According to some embodiments, the image quality criterion could be to check that the value of ROI_{AVE} is within a given percentage of the ROI_{AVE_TARGET}, e.g., as shown in Eqn. 2, below:

$$( 1 ‐ α ) * {ROI}_{AVE \_ TARGET} \leq {ROI}_{AVE} \leq ( 1 + α ) * {ROI}_{AVE \_ TARGET} wherein α = [ 0 .. 1 ] \qquad ( Eqn . 2 )$$

Such techniques may serve to increase system robustness by guaranteeing that the transmitted images have scene details that are more likely to be useful to the downstream algorithms and applications. Moreover, adaptive synchronization with an on-sensor AE algorithm may rely on the presence of an on-sensor frame buffer to store an image before transmitting it when the image quality criterion is met. In addition, because transmission of the image itself can be a significant contributor to the sensor's power consumption, according to some embodiments, the adaptive synchronization techniques described herein may lower the system's power consumption by avoiding the transmission of images that are not likely to have useful content (e.g., images that are under-exposed or over-exposed). In an actual implementation, a maximum limit on the number of image re-captures permitted before image transmission could be set.

In some implementations, a determination to attempt an image re-capture operation could also be made when, e.g., a system ambient light sensor indicates that the average illumination of the scene would be unlikely to result in an image being captured with sufficient details (e.g., the ALS detects a very bright or very dark scene). In other words, the image quality criterion could comprise a determination of whether an ambient illuminance value associated with the capture of a given image is within a threshold amount of a target ambient illuminance value.

It is further noted that, for low lux (i.e., dark) scenes, the image sensor's integration time will usually converge to a value that is large enough that multiple light cycles of the flickering light source take place during the images' capture, and, thus, the problems described above with reference to FIG. 2 (i.e., capturing entire images within the trough of a single light waveform cycle) are less likely to be an issue resulting in the capture of an entirely black image.

In terms of exemplary relative values, the techniques disclosed herein may be applied when the T_{EXP} for an image sensor and the flicker period of the waveform of the light illuminating the scene are comparable. For example, for an image sensor with an exposure time of 2 ms in an environment lit by an artificial light source having a flicker period of 10 ms (i.e., a 100 Hz frequency) with 100% flicker percentage and 50% duty cycle, 5 ms of the 10 ms flicker period would be in complete darkness. Therefore, with an exposure time of 2 ms, there is a chance that a given captured image will be completely dark, and thus would be able to benefit from the adaptive synchronization techniques disclosed herein.

### Exemplary Flicker Mitigation Methods

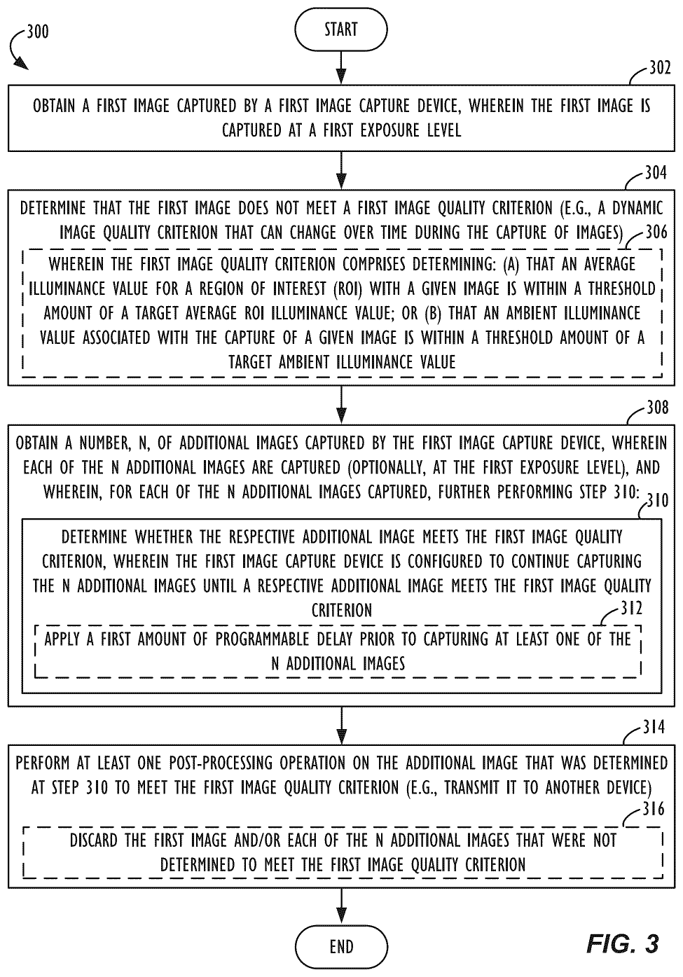

Turning now to FIG. 3, a flow chart illustrating a method 300 of performing flicker mitigation in the presence of a flickering light source is shown, according to one or more embodiments. Method 300 may begin at Step 302 by an electronic device (e.g., a camera device) obtaining a first image captured by a first image capture device (e.g., a rolling shutter image sensor of the electronic device), wherein the first image is captured at a first exposure level (e.g., a first exposure time, EV value, gain level, etc.).

Next, at Step 304, the method 300 may proceed by determining that the first image does not meet a first image quality criterion (e.g., a dynamic image quality criterion that may change over time between the capture of the first image and the capture of a subsequent image). As shown at block 306, according to some embodiments, the first image quality criterion may optionally comprise determining: (a) that an average illuminance value for a region of interest (ROI) with a given image is within a threshold amount of a target average ROI illuminance value; or (b) that an ambient illuminance value associated with the capture of a given image is within a threshold amount of a target ambient illuminance value. Other image quality criterion may be used, based on the needs of a given implementation.

Next, at Step 308, the method 300 may proceed by obtaining a number, n, of additional images captured by the first image capture device, wherein each of the n additional images may optionally be captured at the first exposure level. (In other embodiments, the exposure levels of the n additional images may be dynamic, e.g., according to a known criterion) For each of the n additional images captured, further method 300 may further perform step 310, wherein it is determined whether the respective additional image meets the first image quality criterion, and wherein the first image capture device is configured to continue capturing the n additional images until a respective additional image meets the first image quality criterion (perhaps up to a maximum predetermined number, n, of allowable re-capture attempts). In some implementations, as shown at block 312, the method may further apply a first amount of programmable delay prior to capturing at least one of the n additional images (e.g., to attempt to intentionally push the image capture out of a “valley” or “trough” of the intensity of the flickering light source). In some implementations, the amount of delay may depend on an estimated flickering frequency for the light source (e.g., as determined by a dedicated flicker sensor and/or ambient light sensor).

Finally, at Step 314, the method 300 may proceed by performing at least one post-processing operation on the additional image that was determined at step 310 to meet the first image quality criterion (e.g., transmit it to another device, perform one or more image processing-related operations on it, etc.). According to some implementations, for further efficiency, at Step 316, the method 300 may discard the first image and/or each of the n additional images that were not determined to meet the first image quality criterion.

According to some embodiments, a device's image sensor may preferably be able to act “autonomously” (i.e., be able to determine itself whether the image criterion is satisfied) and thus whether it can omit any power-intensive operation (e.g., transmission of the image), while, in other embodiments, the image sensor may be able to work in conjunction with another processor(s) that will perform the processing to determine if additional image capture attempts are warranted. In the latter case, the other processor(s) may be able to determine whether the image is of sufficient quality that it could be further processed in order to extract whatever useful information any downstream algorithms may be looking for.

### Exemplary Electronic Computing Devices

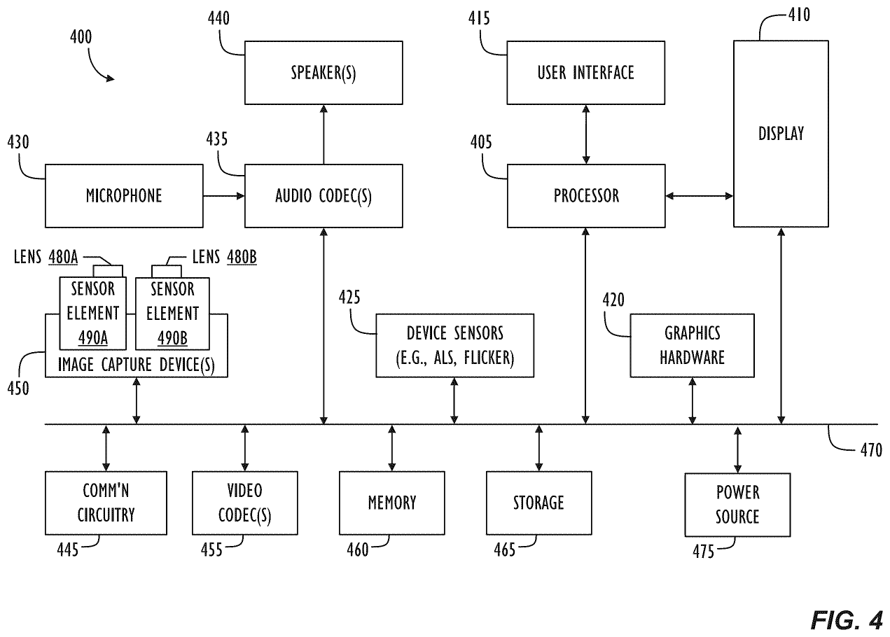

Referring now to FIG. 4, a simplified functional block diagram of illustrative programmable electronic computing device 400 is shown according to one embodiment. Electronic device 400 could be, for example, a mobile telephone, personal media device, portable camera, or a tablet, notebook or desktop computer system. As shown, electronic device 400 may include processor 405, display 410, user interface 415, graphics hardware 420, device sensors 425 (e.g., proximity sensor/ambient light sensor, accelerometer, inertial measurement unit, and/or gyroscope), microphone 430, audio codec(s) 435, speaker(s) 440, communications circuitry 445, image capture device(s) 450, which may, e.g., comprise multiple camera units/optical image sensors having different characteristics or abilities (e.g., Still Image Stabilization (SIS), high dynamic range (HDR), optical image stabilization (OIS) systems, optical zoom, digital zoom, etc.), video codec(s) 455, memory 460, storage 465, and communications bus 470.

Processor 405 may execute instructions necessary to carry out or control the operation of many functions performed by electronic device 400 (e.g., such as the capture and/or processing of images in accordance with the various embodiments described herein). Processor 405 may, for instance, drive display 410 and receive user input from user interface 415. User interface 415 can take a variety of forms, such as a button, keypad, dial, a click wheel, keyboard, display screen and/or a touch screen. User interface 415 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 410 may display a video stream as it is captured while processor 405 and/or graphics hardware 420 and/or image capture circuitry contemporaneously generate and store the video stream in memory 460 and/or storage 465. Processor 405 may be a system-on-chip (SOC) such as those found in mobile devices and include one or more dedicated graphics processing units (GPUs). Processor 405 may be based on reduced instruction-set computer (RISC) or complex instruction-set computer (CISC) architectures or any other suitable architecture and may include one or more processing cores. Graphics hardware 420 may be special purpose computational hardware for processing graphics and/or assisting processor 405 perform computational tasks. In one embodiment, graphics hardware 420 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device(s) 450 may comprise one or more camera units configured to capture images, e.g., images which may be processed to generate enhanced versions of said captured images, e.g., in accordance with this disclosure. Image capture device(s) 450 may include two (or more) lens assemblies 480A and 480B, where each lens assembly may have a separate focal length. For example, lens assembly 480A may have a shorter focal length relative to the focal length of lens assembly 480B. Each lens assembly may have a separate associated sensor element, e.g., sensor elements 490A/490B. Alternatively, two or more lens assemblies may share a common sensor element. Image capture device(s) 450 may capture still and/or video images. Output from image capture device(s) 450 may be processed, at least in part, by video codec(s) 455 and/or processor 405 and/or graphics hardware 420, and/or a dedicated image processing unit or image signal processor incorporated within image capture device(s) 450. Images so captured may be stored in memory 460 and/or storage 465.

Memory 460 may include one or more different types of media used by processor 405, graphics hardware 420, and image capture device(s) 450 to perform device functions. For example, memory 460 may include memory cache, read-only memory (ROM), and/or random access memory (RAM). Storage 465 may store media (e.g., audio, image and video files), computer program instructions or software, preference information, device profile information, and any other suitable data. Storage 465 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 460 and storage 465 may be used to retain computer program instructions or code organized into one or more modules and written in any desired computer programming language. When executed by, for example, processor 405, such computer program code may implement one or more of the methods or processes described herein. Power source 475 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 400.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method of digital image capture, comprising:
obtaining a first image captured by a first image capture device, wherein the first image is captured at a first exposure level;
determining that the first image does not meet a first image quality criterion;
obtaining a number, n, of additional images captured by the first image capture device, wherein for each of the n additional images captured, the method further comprises:
determining whether the respective additional image meets the first image quality criterion,
wherein the first image capture device is configured to continue capturing the n additional images until a respective additional image meets the first image quality criterion; and
performing at least one post-processing operation on the additional image that was determined to meet the first image quality criterion.

2. The method of claim 1, wherein the first image capture device comprises a rolling shutter image sensor, and wherein the first exposure level comprises an integration time for a given row of pixels on the rolling shutter image sensor.

3. The method of claim 1, wherein the first image capture device comprises a global capture image sensor, and wherein the first exposure level comprises an integration time during which all rows of pixels on the global capture image sensor are exposed.

4. The method of claim 1, wherein the first image quality criterion comprises determining that an average illuminance value for a region of interest (ROI) with a given image is within a threshold amount of a target average ROI illuminance value.

5. The method of claim 1, wherein the first image quality criterion comprises determining that an ambient illuminance value associated with the capture of a given image is within a threshold amount of a target ambient illuminance value.

6. The method of claim 1, wherein the first image quality criterion is a dynamic image quality criterion.

7. The method of claim 1, wherein determining that the first image does not meet a first image quality criterion comprises:
determining a presence of light source flicker.

8. The method of claim 7, wherein determining the presence of light source flicker further comprises determining at least one of: an ambient illuminance; a flicker frequency of the light source; or a flicker percentage of the light source.

9. The method of claim 1, further comprising:
discarding the first image; and
discarding each of the n additional images that were not determined to meet the first image quality criterion.

10. The method of claim 1, further comprising:
applying a first amount of programmable delay prior to capturing at least one of the n additional images.

11. An electronic device, comprising:
a memory;
one or more processors; and
a first image capture device, wherein the first image capture device is configured to execute instructions causing the first image capture device to:
capture a first image, wherein the first image is captured at a first exposure level;
determine that the first image does not meet a first image quality criterion;
capture a number, n, of additional images, wherein, for each of the n additional images captured, the first image capture device is further configured to execute instructions causing the first image capture device to:
determine whether the respective additional image meets the first image quality criterion,
wherein the first image capture device is configured to continue capturing the n additional images until a respective additional image meets the first image quality criterion; and
transmit the additional image that was determined to meet the first image quality criterion to the one or more processors for the performance of at least one post-processing operation.

12. The electronic device of claim 11, wherein the first image capture device comprises: (a) a rolling shutter image sensor, wherein the first exposure level comprises an integration time for a given row of pixels on the rolling shutter image sensor; or (b) a global capture image sensor, wherein the first exposure level comprises an integration time during which all rows of pixels on the global capture image sensor are exposed.

13. The electronic device of claim 11, wherein each of the n additional images are captured at the first exposure level.

14. The electronic device of claim 11, wherein the first image quality criterion comprises determining that an average illuminance value for a region of interest (ROI) with a given image is within a threshold amount of a target average ROI illuminance value.

15. The electronic device of claim 11, wherein the first image quality criterion is a dynamic image quality criterion.

16. The electronic device of claim 11, wherein the first image capture device is further configured to execute instructions causing the first image capture device to:
discard the first image; and
discard each of the n additional images that were not determined to meet the first image quality criterion.

17. The electronic device of claim 11, wherein the first image capture device is further configured to execute instructions causing the first image capture device to:
apply a first amount of programmable delay prior to capturing at least one of the n additional images.

18. An electronic device, comprising:
a memory;
a first image capture device; and
one or more processors operatively coupled to the memory, wherein the one or more processors are configured to execute instructions causing the one or more processors to:
obtain a first image captured by a first image capture device, wherein the first image is captured at a first exposure level;
determine that the first image does not meet a first image quality criterion;
obtain a number, n, of additional images captured by the first image capture device, wherein, for each of the n additional images captured, the one or more processors are further configured to execute instructions causing the one or more processors to:
determine whether the respective additional image meets the first image quality criterion,
wherein the first image capture device is configured to continue capturing the n additional images until a respective additional image meets the first image quality criterion; and
perform at least one post-processing operation on the additional image that was determined to meet the first image quality criterion.

19. The electronic device of claim 18, wherein the first image quality criterion comprises determining: (a) that an average illuminance value for a region of interest (ROI) with a given image is within a threshold amount of a target average ROI illuminance value; or (b) that an ambient illuminance value associated with the capture of a given image is within a threshold amount of a target ambient illuminance value.

20. The electronic device of claim 18, further comprising at least one sensor, wherein the instructions causing the one or more processors to determine that the first image does not meet a first image quality criterion further comprise instructions causing the one or more processors to:
determine, using the at least one sensor, a presence of light source flicker,
wherein determining the presence of light source flicker further comprises determining at least one of: an ambient illuminance value; a flicker frequency of the light source; or a flicker percentage of the light source.
